(19) United States
(12) Patent Application Publication
(10) Pub. No.: US 2026/0292633 A1
(43) Pub. Date: Sep. 24, 2026

(54) OPERATIONS ASSOCIATED WITH NTN CELL INFORMATION

(71) Applicant: LENOVO (BEIJING) LIMITED, Beijing (CN)

(72) Inventors: Min Xu, Beijing (CN); Lianhai Wu, Beijing (CN); Jing Han, Beijing (CN)

(21) Appl. No.: 19/480,117

(22) PCT Filed: Oct. 27, 2023
(86) PCT No.: PCT/CN2023/127240

§ 371 Date: Oct. 30, 2025

(51) Int. Cl. H04W 36/14; H04W 84/06

(52) U.S. Cl. CPC H04W 36/144; H04W 84/06

(57) ABSTRACT

Various aspects of the present disclosure relate to operations associated with NTN cell information. In an aspect, a UE receives, from a network entity in a terrestrial network (TN) cell, a configuration comprising information associated with a non-terrestrial network (NTN) cell. The UE performs an operation associated with the information based on the configuration. In this way, a scheme for handling NTN cell information provided in a TN cell may be designed. By handling NTN cell information provided in a TN cell, the communication latency may be decreased and the service continuity may be improved when the UE performs a mobility from a TN cell to a NTN cell.

### TECHNICAL FIELD

The present disclosure relates to wireless communications, and more specifically to a user equipment (UE), a processor for wireless communication, a method, and a non-transitory computer readable medium for performing operations associated with non-terrestrial network (NTN) cell information.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

With the developments of communication technology, more and more communication scenarios may relate to a non-terrestrial network (NTN). A NTN refers to a network or segments of a network using radio frequency (RF) resources on board a satellite. The satellite in NTN can be a geostationary earth orbiting (GEO) satellite with a fixed location to the Earth, or a low earth orbiting (LEO) satellite orbiting around the Earth. The 3rd Generation Partnership Project (3GPP) Release 17 specifications have provided basic supports of NTN features. Further enhancements on operations associated with NTN features need to be studied.

### SUMMARY

The present disclosure relates to a UE, a processor for wireless communication, a method, and a non-transitory computer readable medium for performing operations associated with NTN cell information.

In a first aspect of the solution, a UE receives, from a network entity in a terrestrial network (TN) cell, a configuration comprising information associated with a non-terrestrial network (NTN) cell. The UE performs an operation associated with the information based on the configuration. In this way, a scheme for handling NTN cell information provided in a TN cell may be designed. By handling NTN cell information provided in a TN cell, the communication latency may be decreased and the service continuity may be improved when the UE performs a mobility from a TN cell to a NTN cell.

Some implementations of the method and apparatuses described herein may further include: determining that a serving cell for the UE receiving the configuration is the TN cell based on that an NTN cell indication is absent in a system information block (SIB) of the serving cell.

Some implementations of the method and apparatuses described herein may further include: determining that a serving cell for the UE receiving the configuration is the TN cell based on that the configuration does not include a serving cell part.

In some implementations of the methods and apparatuses described herein, the operation may include: skipping starting a timer indicating a validity of the configuration.

In some implementations of the methods and apparatuses described herein, the operation may include: starting a timer for the NTN cell indicating a validity of the configuration.

In some implementations of the methods and apparatuses described herein, the timer may be started from a system frame or a subframe indicated by an epoch time for the NTN cell based on a timing of the NTN cell or a timing of the TN cell.

In some implementations of the methods and apparatuses described herein, a length of the timer may be equal to a duration of the indicated validity for the NTN cell based on a timing of the NTN cell or a timing of the TN cell.

In some implementations of the methods and apparatuses described herein, the operation may further include: skipping indicating a synchronization lost to a lower layer of the UE in the case of expiry of the timer.

In some implementations of the methods and apparatuses described herein, the timer may be a first timer. The operation may further include one of the following: skipping starting a second timer in the case of expiry of the first timer; or starting a second timer in the case of expiry of the first timer and skipping indicating a synchronization lost to a lower layer of the UE in the case of expiry of the second timer.

In some implementations of the methods and apparatuses described herein, the operation may include: starting a timer for the TN cell indicating a validity of the configuration.

In some implementations of the methods and apparatuses described herein, the timer may be started from a system frame or a subframe indicated by an epoch time for the TN cell based on a timing of the TN cell.

In some implementations of the methods and apparatuses described herein, a length of the timer may be equal to a duration of the indicated validity for the TN cell based on a timing of the TN cell.

In some implementations of the methods and apparatuses described herein, the operation may further include: skipping indicating a synchronization lost to a lower layer of the UE in the case of expiry of the timer.

In some implementations of the methods and apparatuses described herein, the timer may be a third timer. The operation may further include one of the following: skipping starting a fourth timer in the case of expiry of the third timer; or starting a fourth timer in the case of expiry of the third timer and skipping indicating a synchronization lost to a lower layer of the UE in the case of expiry of the fourth timer.

In some implementations of the methods and apparatuses described herein, the operation may further include: skipping requiring a valid version of the configuration in the case of validation of the information.

In some implementations of the methods and apparatuses described herein, the operation may further include: skipping determining a SIB comprising the configuration as an essential SIB for the TN cell.

In some implementations of the methods and apparatuses described herein, the operation may include: in the case that a cell indication is absent in the information, determining to use a same physical cell identifier (PCI) in the NTN cell as in the TN cell.

In some implementations of the methods and apparatuses described herein, the operation may include: in the case that frequency information is absent in the information, determining to use a same frequency in the NTN cell as the TN cell.

In some implementations of the methods and apparatuses described herein, the operation may include: in the case that a parameter of an epoch time is present in the information, determining that at least one of a system frame number (SFN) or a subframe number indicated in the parameter may be based on the TN cell.

In some implementations of the methods and apparatuses described herein, the operation may include: in the case that a parameter of an epoch time is present in the information, determining that at least one of a SFN or a subframe number indicated in the parameter may be based on the NTN cell.

In some implementations of the methods and apparatuses described herein, the operation may include: in the case that a parameter of an epoch time is absent in the information, determining the epoch time as at an end of a system information window where a SIB comprising the configuration may be scheduled in the TN cell.

In some implementations of the methods and apparatuses described herein, the operation may include: in the case that an indication of validity duration is absent in the information, determining that a validity duration may be not applicable for the configuration.

In some implementations of the methods and apparatuses described herein, the operation may include: in the case that an indication of validity duration is absent in the information, determining that the validity duration of the configuration as a default value.

In some implementations of the methods and apparatuses described herein, the operation may include: in the case that an indication of validity duration is absent in the information, determining that the validity duration of the configuration as an infinite value.

In some implementations of the methods and apparatuses described herein, the information may be first information. The UE may be in a connected state. The operation may include: receiving, from the network entity, a configuration for mobility comprising second information associated with the NTN cell; and overriding the first information with the second information for a mobility procedure from the TN cell to the NTN cell.

In some implementations of the methods and apparatuses described herein, the information may be first information. The UE may be in a connected state. The operation may include: in the case that a configuration for mobility comprising second information associated with the NTN cell is not received from the network entity, utilizing the first information for a mobility procedure from the TN cell to the NTN cell.

In some implementations of the methods and apparatuses described herein, the information may be first information. The network entity may be a first network entity. The UE may be in an idle state or an inactive state. The operation may include: receiving, from a second network entity, a configuration for mobility comprising third information associated with the NTN cell; and overriding the first information with the third information for a mobility procedure from the TN cell to the NTN cell.

In some implementations of the methods and apparatuses described herein, the information may be first information. The network entity may be a first network entity. The UE may be in an idle state or an inactive state. The operation may include: in the case that a configuration for mobility comprising third information associated with the NTN cell is not received from the second network entity, utilizing the first information for a random access procedure to the NTN cell.

In some implementations of the methods and apparatuses described herein, the configuration may further include further information associated with at least one further NTN cell. The operation may further include: after a mobility procedure from the TN cell to the NTN cell or a random access procedure to the NTN cell, releasing the further information associated with the at least one further NTN cell.

In some implementations of the methods and apparatuses described herein, the configuration may further include further information associated with at least one further NTN cell. The operation may further include: after a mobility procedure from the TN cell to the NTN cell or a random access procedure to the NTN cell, maintaining the further information associated with the at least one further NTN cell.

### BRIEF DESCRIPTION OF THE DRAWINGS

FIG. 1A illustrates an example of a wireless communications system that supports performing operations associated with NTN cell information in accordance with aspects of the present disclosure.

FIG. 1B illustrates an example of a SIB19 information element designed for a serving NTN cell.

FIG. 1C illustrates an example of a NTN-Config information element in a NTN-NeighCellConfig part in a SIB19 information element.

FIG. 2 illustrates an example signaling chart of an example process that supports performing operations associated with NTN cell information in accordance with aspects of the present disclosure.

FIG. 3 illustrates an example procedure that supports performing operations associated with NTN cell information in accordance with aspects of the present disclosure.

FIG. 4 illustrate an example of a device that supports performing operations associated with NTN cell information in accordance with aspects of the present disclosure.

FIG. 5 illustrate an example of a processor that supports performing operations associated with NTN cell information in accordance with aspects of the present disclosure.

FIGS. 6 through 7 illustrate flowcharts of methods that support performing operations associated with NTN cell information in accordance with aspects of the present disclosure.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), an NR NB (also referred to as a gNB), a remote radio unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an internet of things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As mentioned above, 3GPP Release 17 specifications have provided basic supports of NTN features. In a legacy Release 17 NR/IoT NTN, the serving NTN cell information (the NTN-specific part), including the ephemeris and timing information, is provided in SIB19/SIB31(-NB) to the UE for access via the serving NR/IoT NTN cell.

For example, for NR, a SIB19 has been designed for a serving NTN cell. An UE in RRC_CONNECTED starts a timer T430 for the serving NTN cell upon receiving SIB19. The following is specified in 3GPP technical specification (TS) 38.331:

```
5.2.2.4.21 Actions upon reception of SIB19
Upon receiving SIB19, the UE in RRC_CONNECTED shall:
  1>start or restart T430 for serving cell with the timer value set to
    ntn-UlSyncValidityDuration for the serving cell from the subframe indicated by
    epochTime for the serving cell;
NOTE: UE should attempt to re-acquire SIB19 before the end of the duration indicated
by ntn-UlSyncValidityDuration and epochTime by UE implementation.
```

The T430 is used to ensure that the UE has a valid SIB19 for uplink synchronization to its serving NTN cell. When the T430 expires, the UE considers the uplink synchronization to its serving NTN cell is lost. The following is specified in 3GPP TS38.331:

```
5.2.2.6 T430 expiry
The UE shall:
  1>if T430 for serving cell expires and if in RRC_CONNECTED:
    2>inform lower layers that UL synchronization is lost;
    2>acquire SIB19 as defined in clause 5.2.2.3.2;
    2>upon successful acquisition of SIB19:
      3>inform lower layers when UL synchronization is obtained;
NOTE: The exact time when UL synchronization is obtained (after SIB19 is acquired)
is left to UE implementation, which can be from the subframe indicated by epochTime
and optionally before the subframe indicated by epochTime.
```

Similarly, for LTE, a SIB31(-NB) has been designed for a serving NTN cell. In 3GPP TS36.331, it is specified that an UE in RRC_CONNECTED starts a timer T317 for the serving cell upon receiving SIB31(-NB). Additionally, if T317 expires UE starts another timer T318 to require SIB31(-NB).

In addition, for a serving NTN cell, the SIB19/SIB31(-NB) is an essential SIB for uplink synchronization and an UE in RRC_IDLE and RRC_INACTIVE shall ensure having a valid version of the SIB19/SIB31(-NB). In other words, the UE needs to re-acquire SIB19/SIB31(-NB) in time before reaching its validity duration. If the UE fails to acquire SIB19/SIB31(-NB), the UE shall consider the serving NTN cell as barred.

Due to the very high altitude (e.g., maximum 35786 km) of satellites with onboard antennas, an NTN cell has much a larger coverage (e.g., with a cell range larger than 1000 km) than that of a TN cell (e.g., with a cell range smaller than 10 km). In Release 18 NR NTN discussions, it has been proposed to also support providing such information in a serving TN cell for a neighbour NTN cell for a possible TN-NTN mobility and service continuity purposes. However, since SIB19/SIB31(-NB) is originally designed to be broadcasted in a serving NTN cell for NR/LTE access, some corresponding handlings and UE behaviors are specified only for NTN use. When the NTN cell information is provided in a serving TN cell for a neighbour NTN cell, things would be different.

In view of the above, embodiments of the present disclosure provide a solution for performing operations associated with NTN cell information. In an aspect of the solution, a UE may receive, from a network entity in a terrestrial network (TN) cell, a configuration comprising information associated with a non-terrestrial network (NTN) cell. The UE may perform an operation associated with the information based on the configuration. In this way, a scheme for handling NTN cell information provided in a TN cell may be designed. By handling NTN cell information provided in a TN cell, the communication latency may be decreased and the service continuity may be improved when the UE performs a mobility from a TN cell to a NTN cell.

As used herein, the term “NTN” refers to a network or segments of a network using RF resources on board a satellite. The satellite in NTN can be a GEO satellite with a fixed location to the Earth, or a LEO satellite orbiting around the Earth.

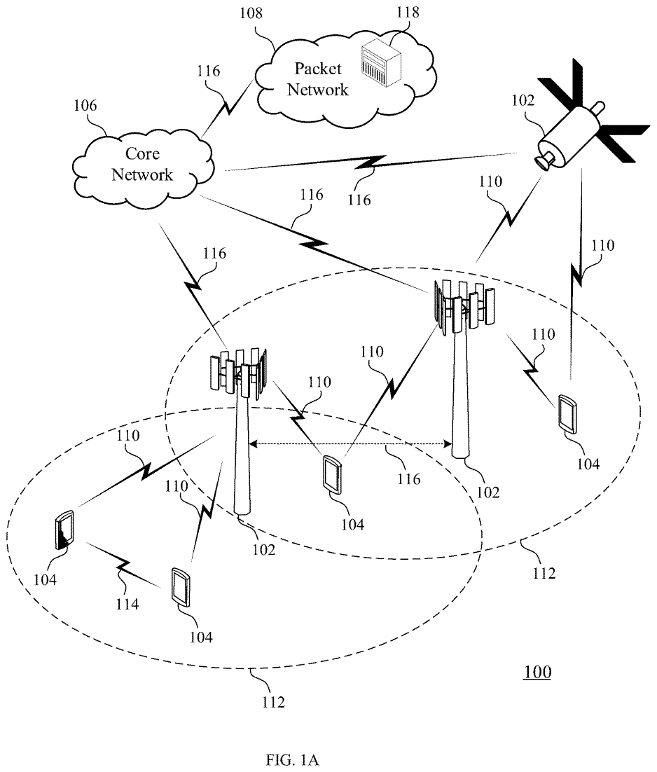

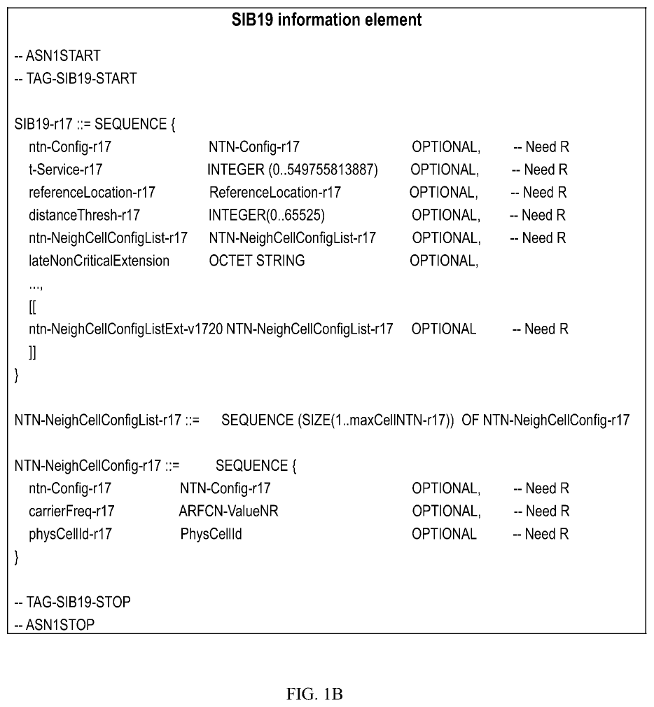

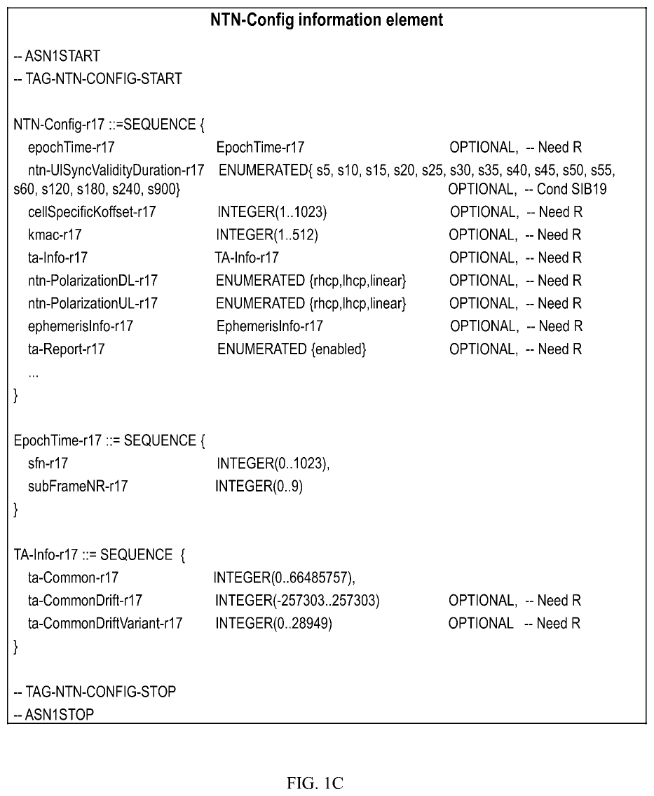

FIG. 1A illustrates an example of a wireless communications system 100 that supports performing operations associated with NTN cell information in accordance with aspects of the present disclosure. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

In NTN scenarios, a network entity 102 may be implemented as a satellite. A network entity 102 in form of a satellite can directly communicate to UE 104 using NR/LTE Uu interface. The satellite may be a transparent satellite or a regenerative satellite. For NTN with a transparent satellite, a base station on earth may communicate with a UE via the satellite. For example, a communication link 110 between the satellite and the UE 104, a communication link 110 between the satellite and a base station on earth, and a communication link 116 between the base station on earth and core network 106 may be used for the NTN transparent mode. For NTN with a regenerative satellite, the base station may be on board and directly communicate with the UE. For example, a communication link 110 between the satellite and the UE 104, and a communication link 116 between the satellite (with full or part of an eNB/gNB on board) and core network 106 may be used for the NTN regenerative mode.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1A. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1A. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

FIG. 1B illustrates an example of a SIB19 information element designed for a serving NTN cell. As shown in FIG. 1B, in a NR NTN, the SIB19 information element for a serving NTN cell may include a serving cell part providing serving NTN cell information and a neighbour cell part (i.e., NTN-NeighCellConfigList part) providing the neighbour NTN cell information. The NTN-NeighCellConfig part may include the following optional parameters/fields: physCellId, carrierFreq and ntn-Config. FIG. 1C illustrates an example of a NTN-Config information element in a NTN-NeighCellConfig part in the SIB19 information element.

Similarly, in a LTE NTN, a SIB31(-NB) information element for a serving NTN cell may include a serving cell part providing serving NTN cell information and a neighbour cell part providing the neighbour NTN cell information. As mentioned above, in a legacy Release 17 NTN, the SIB19/SIB31(-NB) information element is provided in a serving NTN cell. Aspects of the present disclosure are described in the context where the neighbour NTN cell information is provided in a serving TN cell. As used herein, the term “neighbour NTN cell” may be a non-serving NTN cell overlapping, partially-overlapping or close to the serving TN cell.

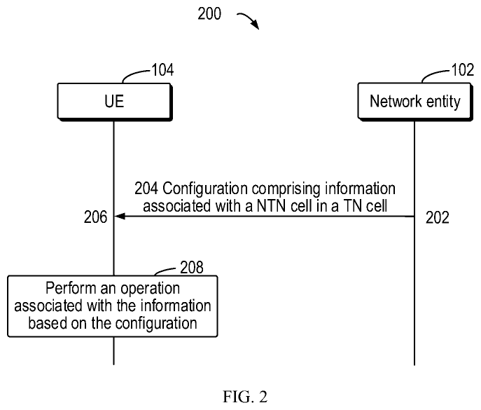

FIG. 2 illustrates an example signaling chart of an example process 200 that supports performing operations associated with NTN cell information in accordance with aspects of the present disclosure. For the purpose of discussion, the process 200 will be described with reference to FIG. 1A, and the process 200 may involve a UE 104 and a network entity 102 as shown in FIG. 1A. The network entity 102 may be implemented as a base station. It is to be understood that the steps and the order of the steps in FIG. 2 are merely for illustration, and not for limitation. It is to be understood that process 200 may further include additional blocks not shown and/or omit some shown blocks, and the scope of the present disclosure is not limited in this regard.

As shown in FIG. 2, the network entity 102 transmits 202 a configuration 204 comprising information associated with a NTN cell in a TN cell. The UE 104 receives 206 the configuration 204 in the TN cell and performs an operation associated with the information based on the configuration 204. The TN cell may be a serving cell of the UE 104. The NTN cell may be a non-serving NTN cell overlapping, partially-overlapping or close to the serving TN cell. In this way, a scheme for handling NTN cell information provided in a TN cell may be designed. By handling NTN cell information provided in a TN cell, the communication latency may be decreased and the service continuity may be improved when the UE performs a mobility from a TN cell to a NTN cell.

In some example embodiments, the UE 104 may determine that a serving cell for the UE 104 receiving the configuration 204 is the TN cell based on that an NTN cell indication is absent in a system information block of the serving cell. For example, if the indication of an NTN cell (e.g., cellBarredNTN) is absent in SIB1 of the serving cell, the UE 104 may recognizes the scenario of receiving information associated with a NTN cell from a serving TN cell.

In some example embodiments, the UE 104 may determine that a serving cell for the UE 104 receiving the configuration 204 is the TN cell based on that the configuration 204 does not include a serving cell part. For example, if the configuration 204 of the serving cell only includes neighbour cell part (e.g., NTN-NeighCellConfigList part), the UE 104 may recognizes the scenario of receiving information associated with a NTN cell from a serving TN cell.

In some example embodiments, the UE 104 may determine that a serving cell for the UE 104 receiving the configuration 204 is the TN cell based on that the configuration 204 includes a serving cell ID different from the ID of the serving TN cell.

Some embodiments of the present disclosure will be described in details below in combination with the potential issues to be solved. It would be appreciated that the embodiments of the present disclosure may be applied to other scenarios or cases.

A first specific aspect is the operations of the UE regarding the timer T430 (for NR) or T317 (for LTE) by the UE in RRC_CONNECTED when the neighbour NTN cell information is provided to the UE in a serving TN cell via the SIB19/SIB31(-NB). As mentioned above, in a legacy Release 17 NR NTN, a valid SIB19 is always required for uplink synchronization of the UE to the serving NTN cell and the timer T430 is used to ensure that UE has a valid SIB19. However, if the SIB19 is provided in a serving TN cell for a neighbour NTN cell, whether the UE has a valid SIB19 has no impact on the uplink synchronization of the UE to the serving TN cell. Therefore, the T430 handling could be different to that in a serving NTN cell. Similarly, if the SIB31(-NB) is provided in a serving TN cell for a neighbour NTN cell, whether the UE has a valid SIB31(-NB) has no impact on the uplink synchronization of the UE to the serving TN cell and the T317 handling could be different to that in a serving NTN cell.

In some example embodiments, the operation may include: skipping starting a timer indicating a validity of the configuration 204. In one example, SIB19/SIB31(-NB) of a neighbour NTN cell may be provided in a serving TN cell to the UE 104 in RRC_CONNECTED, and the UE 104 does not start T430/T317 upon reception of this SIB19/SIB31(-NB) of a neighbour NTN cell. In a more specific example, when cellBarredNTN is absent in SIB1 or when SIB19 only includes NTN-NeighCellConfigList part or when SIB31(-NB) includes a cell ID different from the serving cell, the UE 104 may receive SIB19/SIB31(-NB) in a TN cell but does not start T430/T317.

In some embodiments, the UE 104 is not required to ensure having a valid version of the SIB19/SIB31(-NB) of a neighbour NTN cell and can determine to re-acquire this SIB19/SIB31(-NB) of a neighbour NTN cell whenever necessary. In some examples, the UE 104 does not consider the serving TN cell as barred if the UE 104 fails to acquire the SIB19/SIB31(-NB) of a neighbour NTN cell. The UE 104 does not consider this SIB19/SIB31(-NB) of a neighbour NTN cell as an essential SIB for the serving TN cell.

In some example embodiments, the operation may include: starting a timer for the NTN cell indicating a validity of the configuration 204. In one example, SIB19/SIB31(-NB) of a neighbour NTN cell may be provided in a serving TN cell to the UE 104 in RRC_CONNECTED, and the UE starts T430/T317 for the neighbour NTN cell upon reception of this SIB19/SIB31(-NB) of a neighbour NTN cell. In a more specific example, when cellBarredNTN is absent in SIB1 or when SIB19 only includes NTN-NeighCellConfigList part or when SIB31(-NB) includes a cell ID different from the serving cell, the UE 104 may start T430/T317 for the neighbour NTN cell, but is not required to ensure having a valid version of this SIB19/SIB31(-NB) of a neighbour NTN cell.

In some cases, there may be multiple the neighbour NTN cells. The UE may receive information for the multiple the neighbour NTN cells in the serving TN cell and stars multiple T430/T317 timers for these the neighbour NTN cells. In some examples, if the UE 104 moves to one of the neighbouring NTN cells, the T430/T317 for any other the neighbour NTN cell can be stopped.

In some embodiments, the operation may further include: skipping indicating a synchronization lost to a lower layer of the UE 104 in the case of expiry of the timer. In one example implementation, for NR, if SIB19 is provided in a TN cell (e.g., when cellBarredNTN is absent in SIB1 or when SIB19 includes NTN-NeighCellConfigList part), a T430 for a neighbour NTN cell may be started upon reception of SIB19. The UE 104 does not indicate the lower layers of synchronization lost upon expiry of T430, and does not inform lower layers when UL synchronization is obtained upon successful acquisition of SIB19. The UE 104 can determine to re-acquire SIB19 for the neighbour NTN cell when necessary.

In some embodiments, the timer may be a first timer. The operation may further include: skipping starting a second timer in the case of expiry of the first timer. In one example implementation, for LTE, if SIB31(-NB) is provided in a TN cell (e.g., when cellBarredNTN is absent in SIB1 or when SIB31(-NB) includes a cell ID different from the serving cell), T317 for a neighbour NTN cell may be started upon reception of SIB31(-NB). The UE 104 does not start T318 for the neighbour NTN cell upon T317 expiry and does not inform lower layers when UL synchronization is obtained upon successful acquisition of SIB31(-NB). The UE 104 can determine to re-acquire SIB31(-NB) for the neighbour NTN cell upon T317 expiry or when necessary.

In some embodiments, the timer may be a first timer. The operation may further include: starting a second timer in the case of expiry of the first timer and skipping indicating a synchronization lost to a lower layer of the UE 104 in the case of expiry of the second timer. In one example implementation, for LTE, if SIB31(-NB) is provided in a TN cell (e.g., when cellBarredNTN is absent in SIB1 or when SIB31(-NB) includes a cell ID different from the serving cell), T317 for a neighbour NTN cell may be started upon reception of SIB31(-NB). The UE 104 starts T318 for the neighbour NTN cell upon T317 expiry, does not indicate lower layer of synchronization lost upon T318 expiry, and does not inform lower layers when UL synchronization is obtained upon successful acquisition of SIB31(-NB). The UE 104 can determine to re-acquire SIB31(-NB) for the neighbour NTN cell upon T318 expiry or when necessary.

In some embodiments, the timer may be started from a system frame or a subframe indicated by an epoch time for the NTN cell based on a timing of the NTN cell or a timing of the TN cell. For example, the T430/T317 may be started from the subframe indicated by epochTime for the neighbour NTN cell based on a serving TN cell timing or based on a neighbour NTN cell timing.

In some embodiments, a length of the timer may be equal to a duration of the indicated validity for the NTN cell based on a timing of the NTN cell or a timing of the TN cell. For example, the UE 104 may set a duration of T430/T317 to ntn-UlSyncValidityDuration for the neighbour NTN cell based on a serving TN cell timing or based on a neighbour NTN cell timing.

In some embodiments, the UE 104 is not required to ensure having a valid version of the SIB19/SIB31(-NB) of a neighbour NTN cell and can determine to re-acquire this SIB19/SIB31(-NB) of a neighbour NTN cell whenever necessary. In some examples, the UE 104 does not consider the serving TN cell as barred if the UE 104 fails to acquire the SIB19/SIB31(-NB) of a neighbour NTN cell. The UE 104 does not consider this SIB19/SIB31(-NB) of a neighbour NTN cell as an essential SIB for the serving TN cell.

In some example embodiments, the operation may include: starting a timer for the TN cell indicating a validity of the configuration 204. In one example, SIB19/SIB31(-NB) may be provided in a serving TN cell to the UE 104 in RRC_CONNECTED, and the UE starts T430/T317 for the serving TN cell upon reception of this SIB19/SIB31(-NB).

In a more specific example, when cellBarredNTN is absent in SIB1 or when SIB19 only includes NTN-NeighCellConfigList part or when SIB31(-NB) includes a cell ID different from the serving cell, the UE 104 may start T430/T317 for the serving cell as in legacy. The T430/T317 may be common for all the neighbour NTN cells with information of the neighbour NTN cells provided in the serving TN cell.

In some embodiments, the operation may further include: skipping indicating a synchronization lost to a lower layer of the UE 104 in the case of expiry of the timer. In one example implementation, for NR, if SIB19 is provided in a TN cell (e.g., when cellBarredNTN is absent in SIB1 or when SIB19 includes NTN-NeighCellConfigList part), a T430 for the serving TN cell may be started upon reception of SIB19 SIB19. The UE 104 does not indicate the lower layers of synchronization lost upon T430 expiry, and does not inform the lower layers when UL synchronization is obtained upon successful acquisition of SIB19. The UE 104 can determine to re-acquire SIB19 when necessary.

In some embodiments, the timer may be a third timer. The operation may further include: skipping starting a fourth timer in the case of expiry of the third timer. In one example implementation, for LTE, if SIB31(-NB) is provided in a TN cell (e.g., when cellBarredNTN is absent in SIB1 or when SIB31(-NB) includes a cell ID different from the serving cell), T317 for the serving TN cell is started upon reception of SIB31(-NB). The UE 104 does not start T318, and does not inform lower layers when UL synchronization is obtained upon successful acquisition of SIB31(-NB). The UE 104 can determine to re-acquire SIB31(-NB) upon T318 expiry or when necessary.

In some embodiments, the timer may be a third timer. The operation may further include: starting a fourth timer in the case of expiry of the third timer and skipping indicating a synchronization lost to a lower layer of the UE 104 in the case of expiry of the fourth timer. In one example implementation, for LTE, if SIB31(-NB) is provided in a TN cell (e.g., when cellBarredNTN is absent in SIB1 or when SIB31(-NB) includes a cell ID different from the serving cell), T317 for the serving TN cell is started upon reception of SIB31(-NB). The UE 104 starts T318 upon T317 expiry, does not indicate lower layer of synchronization lost upon T318 expiry, and does not inform lower layers when UL synchronization is obtained upon successful acquisition of SIB31(-NB). The UE 104 can determine to re-acquire SIB31(-NB) upon T318 expiry or when necessary.

In some embodiments, the timer may be started from a system frame or a subframe indicated by an epoch time for the TN cell based on a timing of the TN cell. For example, the T430/T317 may be started from the subframe indicated by epochTime for the serving TN cell based on serving TN cell.

In some embodiments, a length of the timer may be equal to a duration of the indicated validity for the TN cell based on a timing of the TN cell. For example, the UE 104 may set a duration of T430/T317 to ntn-UlSyncValidityDuration for the serving TN cell based on serving TN cell.

In some embodiments, the UE 104 is not required to ensure having a valid version of the SIB19/SIB31(-NB) and can determine to re-acquire this SIB19/SIB31(-NB) whenever necessary. In some examples, the UE 104 does not consider the serving TN cell as barred if the UE 104 fails to acquire the SIB19/SIB31(-NB). The UE 104 does not consider this SIB19/SIB31(-NB) as an essential SIB for the serving TN cell.

A second specific aspect is to design the UE operations when the UE in RRC_IDLE and RRC_INACTIVE acquires SIB19/SIB31(-NB) in a serving TN cell. As mentioned above, for a serving NTN cell, the SIB19/SIB31(-NB) is an essential SIB for uplink synchronization and an UE in RRC_IDLE and RRC_INACTIVE shall ensure having a valid version of the SIB19/SIB31(-NB). However, if the SIB19 SIB19/SIB31(-NB) is provided in a serving TN cell for a neighbour NTN cell, the SIB19 SIB19/SIB31(-NB) should not be an essential SIB and thus the handling of the SIB19 SIB19/SIB31(-NB) provided in a serving TN cell should be different to that in a serving NTN cell.

In some example embodiments, the operation may further include: skipping requiring a valid version of the configuration 204 in the case of expiry of validation of the information. For example, when SIB19/SIB31(-NB) of a neighbour NTN cell is provided in a serving TN cell to a UE in RRC_IDLE/INACTIVE, the UE 104 in RRC_IDLE and RRC_INACTIVE is not required to ensure having a valid version of this SIB19/SIB31(-NB) of a neighbour NTN cell. In one example, for NR access, the UE 104 does not inform lower layers when UL synchronization is obtained upon successful acquisition of SIB19. In another example, for LTE access, the UE 104 does not inform lower layers when UL synchronization is obtained upon successful acquisition of SIB31(-NB).

In one implementation, the UE 104 in RRC_IDLE and RRC_INACTIVE can determine to re-acquire this SIB19/SIB31(-NB) of a neighbour NTN cell whenever necessary. In another implementation, the UE 104 in RRC_IDLE and RRC_INACTIVE can re-acquire the information after the ephemeris information of the NTN neighbour cell expires.

In some example embodiments, the operation may further include: skipping determining a system information block comprising the configuration 204 as an essential SIB for the TN cell. In other words, the UE 104 does not consider the serving TN cell as barred if the UE 104 fails to acquire this SIB19/SIB31(-NB) of a neighbour NTN cell. In one example, if SIB19/SIB31(-NB) is scheduled in SIB1 of a serving TN cell and UE fails to acquire the SIB19/SIB31(-NB), the UE 104 does not consider the serving TN cell as barred. In other words, the UE 104 does not consider the SIB19/SIB31(-NB) as an essential SIB for the serving TN cell.

A third specific aspect is to design the UE operations when some parameters in the neighbour NTN cell information are present or absent. If the SIB19 is provided in a serving TN cell for a neighbour NTN cell, it is expected that the SIB19 does not include the serving cell part but only the neighbour cell part (i.e., NTN-NeighCellConfigList part). However, as in the SIB19 designed for a serving NTN cell, some of the parameters of the NTN-NeighCellConfigList part have dependence on the parameters of the serving cell part which are not expected to be presented when the SIB19 is provided in a TN cell for a neighbour NTN cell. Similar potential issues exist for SIB31(-NB) provided in a serving TN cell for a neighbour NTN. In some scenarios, if the neighbour NTN cell information are provided in other SIBs such as SIB3/SIB4/SIB5 in a serving TN cell, such issues remain to be solved.

In some example embodiments, the operation may include: determining to use a same physical cell identifier (PCI) in the NTN cell as in the TN cell if a cell indication is absent in the information. For example, if SIB19/SIB31(-NB) of a neighbour NTN cell is provided in a serving TN cell to a UE and if the cell ID of the neighbour NTN cell is absent, the UE 104 may consider the mobility from the serving TN cell to the neighbour NTN cell as PCI unchanged (i.e., the neighbour NTN cell uses the same PCI as that in serving TN cell). In a more specific example, if the UE 104 receives SIB19 for a neighbour NTN cell in a serving TN cell and the parameter physCellId is absent in the NTN-NeighCellConfig part in SIB19, the UE 104 may consider a PCI unchanged scenario, i.e., the neighbour NTN cell uses the same PCI as that in the serving TN cell.

In some example embodiments, the operation may include: determining to use a same frequency in the NTN cell as the TN cell if frequency information is absent in the information. For example, if SIB19/SIB31(-NB) of a neighbour NTN cell is provided in a serving TN cell to a UE and if frequency information is absent, the UE 104 may consider the mobility from the serving TN cell to the neighbour NTN cell as intra-frequency (i.e., the neighbour NTN cell uses the same frequencies as that in serving TN cell). In a more specific example, if the UE 104 receives SIB19 for a neighbour NTN cell in a serving TN cell and the parameter carrierFreq is absent in the NTN-NeighCellConfig part in SIB19, the UE 104 may consider an intra-frequency between TN and NTN, i.e., the neighbour NTN cell uses the same frequencies as that in serving TN cell.

In some example embodiments, the operation may include: determining that at least one of a system frame number (SFN) or a subframe number indicated in the parameter may be based on the TN cell if a parameter of an epoch time is present in the information. For example, if SIB19/SIB31(-NB) of a neighbour NTN cell is provided in a serving TN cell to a UE and if epoch time is presented, the UE 104 may consider the SFN and subframe numbers indicated are based on serving TN cell. In a more specific example, if the UE 104 receives SIB19 for a neighbour NTN cell in a serving TN cell and the parameter epochTime is present in the NTN-Config information element in the NTN-NeighCellConfig part in SIB19, the SFN and the subframe numbers indicated by the epochTime may be based on the serving TN cell.

In some example embodiments, the operation may include: determining that at least one of a SFN or a subframe number indicated in the parameter may be based on the NTN cell if a parameter of an epoch time is present in the information. For example, if SIB19/SIB31(-NB) of a neighbour NTN cell is provided in a serving TN cell to a UE and if epoch time is presented, the UE 104 may consider the SFN and subframe numbers indicated are based on the neighbour NTN cell if the timing difference information between serving TN cell and the neighbour NTN cell is available. In a more specific example, if the UE 104 receives SIB19 for a neighbour NTN cell in a serving TN cell and the parameter epochTime is present in the NTN-Config information element in the NTN-NeighCellConfig part in SIB19, the SFN and the subframe numbers indicated by the epochTime may be based on the neighbour NTN cell.

In some example embodiments, the operation may include: determining the epoch time as at an end of a system information window where a system information block comprising the configuration 204 may be scheduled in the TN cell if a parameter of an epoch time is absent in the information. For example, if SIB19/SIB31(-NB) of a neighbour NTN cell is provided in a serving TN cell to a UE and if epoch time is absent, the UE 104 may consider the epoch time as the end of SI window where this SIB19/SIB31(-NB) is scheduled in the serving TN cell. In a more specific example, if the UE 104 receives SIB19 for a neighbour NTN cell in a serving TN cell and the parameter epochTime is absent in the NTN-Config information element in the NTN-NeighCellConfig part in SIB19, the epoch time may be determined as the end of system information window where this SIB19 is scheduled in the serving TN cell.

In some example embodiments, the operation may include: determining that a validity duration may be not applicable for the configuration 204 if an indication of validity duration is absent in the information. In some example embodiments, the operation may include: determining that the validity duration of the configuration 204 as a default value if an indication of validity duration is absent in the information. In some example embodiments, the operation may include: determining that the validity duration of the configuration 204 as an infinite value if an indication of validity duration is absent in the information.

For example, if SIB19/SIB31(-NB) of a neighbour NTN cell is provided in a serving TN cell to a UE and if validity duration is absent, the UE 104 may consider the validity duration as not applicable or as a default value or as infinity. In a more specific example, if the UE 104 receives SIB19 for a neighbour NTN cell in a serving TN cell and the parameter ntn-UlSyncValidityDuration is absent in the NTN-Config information element in the NTN-NeighCellConfig part in SIB19, the UE 104 may consider the validity duration as not applicable, or as a default value or as an infinity.

In one example implementation, the configuration 204 may be provided in SIB19 for a neighbour NTN cell. The information associated with a NTN cell may include the NTN-NeighCellConfigList part in SIB19. In some scenarios, some optional parameters in the NTN-NeighCellConfigList part may be absent or present. For example, the carrierFreq in the NTN-NeighCellConfig part could be absent if serving TN cell and the neighbour NTN cell use the same frequencies. In addition, parameters in the ntn-Config information element in the NTN-NeighCellConfig part may be present or absent. Table 1 shows some example operations of the UE in case of presence or absence of some parameters for a neighbour NTN cell.

TABLE 1
Example operations of UE regarding presence or
absence of parameters for a neighbour NTN cell

| Parameters for a neighbour | | |
|---|---|---|
| NTN cell | handling when presented | handling when absent |
| physCellId | As in legacy | Consider as PCI unchanged |
| | | scenario (neighbour NTN cell |
| | | uses the same PCI as that in |
| | | serving TN cell) |
| carrierFreq | As in legacy | Consider as intra-frequency |
| | | between TN and NTN |
| | | (neighbour NTN cell uses the |
| | | same frequencies as that in |
| | | serving TN cell) |
| epochTime | The SFN and subframe | The epoch time is the end of |
| | numbers indicated are | SI window where this SIB19 |
| | based on serving TN cell. | is scheduled in the serving |
| | The SFN and subframe | TN cell. |
| | numbers indicated are | |
| | based on the neighbour | |
| | NTN cell, if the timing | |
| | difference information | |
| | between serving TN cell | |
| | and the neighbour NTN | |
| | cell is available. | |
| ntn-UlSyncValidityDuration | As in legacy | UE considers the validity |
| | | duration as not applicable. |
| | | UE considers the validity |
| | | duration as default value. |
| | | UE considers the validity |
| | | duration as infinity. |

It should be understood that these parameters and related UE operations shown in Table 1 are merely for illustration and not intended to be limiting. In some implementations, parameters related to information of a neighbour NTN cell may be configured in SIB31(-NB) or SIB3/SIB4/SIB5 or other SIBs in s serving TN cell and the UE operations may be configured or specified in a similar manner when these parameters are present or absent.

A fourth specific aspect is to design the UE operations when the UE performs a mobility procedure from the serving TN cell to a neighbour NTN cell. For the mobility of a UE in RRC_CONNECTED, i.e., handover/conditional handover (HO/CHO), from the serving TN cell to a target or candidate NTN cell, SIB19/SIB31(-NB) of the target or candidate NTN cell may be provided in the HO/CHO configurations. For the mobility of a UE in RRC_INACTIVE or RRC_IDLE, i.e., cell reselection, SIB19/SIB31(-NB) of a NTN cell is expected to be provided in the NTN cell by broadcasting and the UE in RRC_INACTIVE or RRC_IDLE can obtain the SIB19/SIB31(-NB) of the NTN cell when the cell reselection to that NTN cell is completed. The UE operations on the SIB19/SIB31(-NB) newly obtained in the mobility procedure and the neighbour NTN cell information previously obtained in the TN cell before the mobility procedure should be designed. In some scenarios, if the neighbour NTN cell information are provided in other SIBs such as SIB3/SIB4/SIB5 in a serving TN cell, such issues remain to be solved.

In some example embodiments, the information may be first information. The UE 104 may be in a connected state. The operation may include: receiving, from the network entity 102, a configuration for mobility comprising second information associated with the NTN cell; and overriding the first information with the second information for a mobility procedure from the TN cell to the NTN cell.

In some example embodiments, the information may be first information. The UE 104 may be in a connected state. The operation may include: utilizing the first information for a mobility procedure from the TN cell to the NTN cell if a configuration for mobility comprising second information associated with the NTN cell is not received from the network entity 102.

In some example embodiments, the information may be first information. The network entity 102 may be a first network entity 102. The UE 104 may be in an idle state or an inactive state. The operation may include: receiving, from a second network entity 102, a configuration for mobility comprising third information associated with the NTN cell; and overriding the first information with the third information for a mobility procedure from the TN cell to the NTN cell. The second network entity may be implemented as a satellite.

In some example embodiments, the information may be first information. The network entity 102 may be a first network entity 102. The UE 104 may be in an idle state or an inactive state. The operation may include: if a configuration for mobility comprising third information associated with the NTN cell is not received from the second network entity 102, utilizing the first information for a random access procedure to the NTN cell. The second network entity may be implemented as a satellite.

In some example embodiments, the configuration 204 may further include further information associated with at least one further NTN cell. The operation may further include: after a mobility procedure from the TN cell to the NTN cell or a random access procedure to the NTN cell, releasing the further information associated with the at least one further NTN cell.

In some example embodiments, the configuration 204 may further include further information associated with at least one further NTN cell. The operation may further include: after a mobility procedure from the TN cell to the NTN cell or a random access procedure to the NTN cell, maintaining the further information associated with the at least one further NTN cell.

In one example implementation, SIB19/SIB31(-NB) of a neighbour NTN cell may be provided in a serving TN cell to a UE, and for the UE in RRC_CONNECTED, if SIB19/SIB31(-NB) of a target/candidate NTN cell is provided in HO/CHO configurations, the SIB19/SIB31(-NB) provided in HO/CHO configurations may override the SIB19/SIB31(-NB) provided in TN cell broadcast upon reception or upon HO/CHO execution. The UE may release or keep the SIB19/SIB31(-NB) provided in TN cell broadcast for an NTN cell other than the target/candidate NTN cell the UE handovers to.

In one example implementation, SIB19/SIB31(-NB) of a neighbour NTN cell may be provided in a serving TN cell to a UE, and for the UE in RRC_CONNECTED, if SIB19/SIB31(-NB) of a target/candidate NTN cell is not provided in HO/CHO configurations, the SIB19/SIB31(-NB) provided in TN cell broadcast can be used for HO/CHO, or the UE may release the SIB19/SIB31(-NB) provided in TN cell broadcast after HO/CHO is performed. The UE may release or keep the SIB19/SIB31(-NB) provided in TN cell broadcast for an NTN cell other than the target/candidate NTN cell the UE handovers to.

In one example implementation, SIB19/SIB31(-NB) of a neighbour NTN cell may be provided in a serving TN cell to a UE, and for the UE in RRC_IDLE or RRC_INACTIVE, if the UE successfully obtains SIB19/SIB31(-NB) in the NTN cell, the SIB19/SIB31(-NB) newly obtained in the NTN cell overrides the SIB19/SIB31(-NB) provided in TN cell broadcast upon reception of SIB19/SIB31(-NB) in the NTN cell. The UE may release or keep the SIB19/SIB31(-NB) provided in TN cell broadcast for an NTN cell other than the target NTN cell the UE reselects to.

In one example implementation, SIB19/SIB31(-NB) of a neighbour NTN cell may be provided in a serving TN cell to a UE, and for the UE in RRC_IDLE or RRC_INACTIVE, if the UE fails to obtain SIB19/SIB31(-NB) in the NTN cell, the SIB19/SIB31(-NB) provided in TN cell broadcast can be used for access or the UE may consider the NTN cell as barred. The UE may release or keep the SIB19/SIB31(-NB) provided in TN cell broadcast for an NTN cell other than the target NTN cell the UE reselects to.

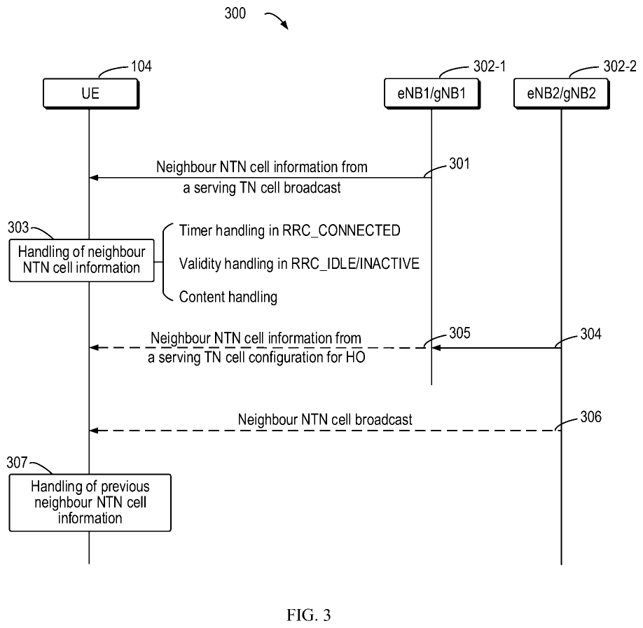

FIG. 3 illustrates an example procedure 300 that supports performing operations associated with NTN cell information in accordance with aspects of the present disclosure. For the purpose of discussion, the communication process 300 will be described with reference to FIG. 1A. It would be appreciated that although the communication process 300 has been described referring to the network environment 100 of FIG. 1A, this communication process 300 may be likewise applied to other similar communication scenarios. The communication process 300 may be regarded as a specific example implementation of the process 200 of FIG. 2. The procedure 300 may involve the UE 104, an eNB1/gNB1 302-1, and an eNB2/gNB2 302-2. The eNB1/gNB1 302-1 may be a specific example of the network entity 102 serving the UE 104 in the process 200 as shown in FIG. 2. The eNB1/gNB1 302-1 may be implemented as a serving BS on Earth and provide a serving TN cell. The eNB2/gNB2 302-2 may be implemented as a satellite and provide a NTN cell. The NTN cell may be overlapped, partially overlapped or close to the serving TN cell.

As shown in FIG. 3, a UE 104 receives 301 a first configuration including at least one the neighbour NTN cell information from the eNB1/gNB1 302-1 in a serving TN cell, and handles 303 the neighbour NTN cell information based on the first configuration.

In some examples, the UE 104 may recognizes the first configuration from a serving TN cell by at least one of the following: the indication of an NTN cell (e.g., cellBarredNTN) is absent in SIB1 of the serving cell; or the first configuration of the serving cell only includes neighbour cell part (e.g., NTN-NeighCellConfigList); or the first configuration of the serving cell includes a cell ID different from the serving cell.

In some implementations, the UE 104 may not start a first timer (e.g., neighbour cell T430 in NR) or a second timer (e.g., neighbour cell T317 in LTE) indicating the validity of the first configuration for the serving TN cell or the neighbour NTN cell upon reception of the first configuration.

Alternatively, the UE 104 may start a first timer (e.g., neighbour cell T430 in NR) or a second timer (e.g., neighbour cell T317 in LTE) indicating the validity of the first configuration for the neighbour NTN cell upon reception of the first configuration. The first timer (e.g., neighbour cell T430 in NR) or the second timer (e.g., neighbour cell T317 in LTE) may be started from the subframe indicated by the epoch time for the neighbour NTN cell. The length of the first timer (e.g., neighbour cell T430 in NR) or the second timer (e.g., neighbour cell T317 in LTE) may be equal to the indicated validity duration for the neighbour NTN cell. For NR, the UE 104 may not indicate lower layer of synchronization lost upon expiry of the first timer. For LTE, the UE 104 may not start a third timer (e.g., neighbour cell T318 in LTE) upon expiry of the second timer, or starts a third timer (e.g., neighbour cell T318 in LTE) upon expiry of the second timer and does not indicate lower layer of synchronization lost upon expiry of the third timer.

Alternatively, the UE 104 may start a fourth timer (e.g., serving cell T430 in NR) or a fifth timer (e.g., serving cell T317 in LTE) indicating the validity of the first configuration for the serving TN cell upon reception of the first configuration. The fourth timer (e.g., serving cell T430 in NR) or the fifth timer (e.g., serving cell T317 in LTE) is started from the subframe indicated by the epoch time for the serving TN cell. The length of the fourth timer (T430 in NR) or the fifth timer (T317 in LTE) may be equal to the indicated validity duration for the serving TN cell. For NR, the UE 104 may not indicate lower layer of synchronization lost upon expiry of the fourth timer. For LTE, the UE 104 may not start a sixth timer (e.g., serving cell T318 in LTE) upon expiry of the fifth timer, or starts a sixth timer (e.g., serving cell T318 in LTE) upon expiry of the fifth timer and does not indicate lower layer of synchronization lost upon expiry of the sixth timer.

In some implementations, the UE 104 may be not required to always ensure having a valid version of the first configuration. The UE 104 may not consider the SIB in the first configuration as an essential SIB for the serving TN cell.

In some implementations, the UE 104 may handle at least one of the parameters in the first configuration. For example, if a cell ID is absent, the UE 104 may consider the neighbour NTN cell uses the same PCI as that in serving TN cell. If frequency information is absent, the UE 104 may consider the neighbour NTN cell uses the same frequencies as that in serving TN cell. If epoch time is presented, the UE 104 may consider the SFN and subframe numbers indicated are based on serving TN cell, or are based on the neighbour NTN cell if the timing difference information between serving TN cell and the neighbour NTN cell is available. If epoch time is absent, the UE 104 may consider the epoch time as the end of SI window where this SIB19/SIB31(-NB) is scheduled in the serving TN cell. If validity duration is absent, the UE 104 may consider the validity duration as not applicable or as a default value or as infinity.

In some implementations, when the UE 104 in RRC_CONNECTED performs a HO/CHO from a TN cell to a NTN cell, the UE 104 in RRC_CONNECTED may receive 305 a second configuration including at least one the same the neighbour NTN cell information for mobility from the eNB1/gNB1 302-1 associated with the TN cell. The eNB1/gNB1 302-1 may obtain 304 the second configuration from the eNB2/gNB2 302-2 providing the NTN cell that the UE 104 handovers to. If the UE 104 in RRC_CONNECTED receives 305 the second configuration including at least one the same the neighbour NTN cell information for mobility, at 307, the UE 104 may override the information from the first configuration with the information from the second configuration for the mobility procedures. Else, if the UE 104 does not receive a second configuration including at least one the same the neighbour NTN cell information for mobility, at 307, the UE 104 may use the information from the first configuration for the mobility procedures.

In some implementations, when the UE 104 in RRC_IDLE or RRC_INACTIVE moves from a TN cell to a NTN cell, the UE 104 in RRC_IDLE or RRC_INACTIVE may receive 306 a third configuration including at least one the same the neighbour NTN cell information for mobility in the NTN cell broadcast. If the UE 104 in RRC_IDLE or RRC_INACTIVE receives the third configuration including at least one the same the neighbour NTN cell information for mobility, at 307, the UE 104 may override the information from the first configuration with the information from the third configuration for the mobility procedures. Else, if the UE 104 in RRC_IDLE or RRC_INACTIVE does not receive a third configuration including at least one the same the neighbour NTN cell information for uplink synchronization, at 307, the UE 104 may use the information from the first configuration for the random access procedures.

Some embodiments of the present disclosure propose a series of solutions for handling neighbour NTN cell information provided in a serving TN cell, aiming to solve the potential issues due to providing SIB19, which is originally designed for a serving NTN cell, in a serving TN cell, so as to decrease the communication latency and improve the service continuity when the UE performs a mobility from a serving TN cell to a neighbour NTN cell.

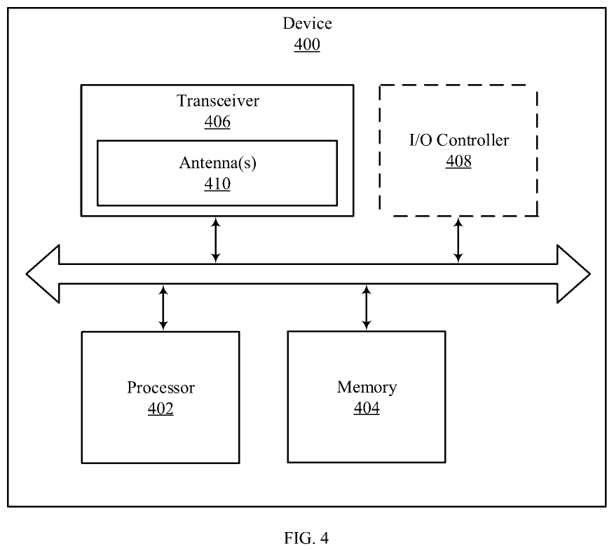

FIG. 4 illustrates an example of a device 400 that supports performing operations associated with NTN cell information in accordance with aspects of the present disclosure. The device 400 may be an example of a UE 104 as described herein. The device 400 may support wireless communication with one or more network entities 102, UEs 104, or any combination thereof. The device 400 may include components for bi-directional communications including components for transmitting and receiving communications, such as a processor 402, a memory 404, a transceiver 406, and, optionally, an I/O controller 408. These components may be in electronic communication or otherwise coupled (e.g., operatively, communicatively, functionally, electronically, electrically) via one or more interfaces (e.g., buses).

The processor 402, the memory 404, the transceiver 406, or various combinations thereof or various components thereof may be examples of means for performing various aspects of the present disclosure as described herein. For example, the processor 402, the memory 404, the transceiver 406, or various combinations or components thereof may support a method for performing one or more of the operations described herein.

In some implementations, the processor 402, the memory 404, the transceiver 406, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 402 and the memory 404 coupled with the processor 402 may be configured to perform one or more of the functions described herein (e.g., executing, by the processor 402, instructions stored in the memory 404).

For example, the processor 402 may support wireless communication at the device 400 in accordance with examples as disclosed herein. The processor 402 may be configured to operable to support a means for receiving, from a network entity in a terrestrial network (TN) cell, a configuration comprising information associated with a non-terrestrial network (NTN) cell; and a means for performing an operation associated with the information based on the configuration.

The processor 402 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 402 may be configured to operate a memory array using a memory controller. In some other implementations, a memory controller may be integrated into the processor 402. The processor 402 may be configured to execute computer-readable instructions stored in a memory (e.g., the memory 404) to cause the device 400 to perform various functions of the present disclosure such that the device 400 may perform any process of the disclosure as discussed with reference to FIGS. 2 to 3.

The memory 404 may include random access memory (RAM) and read-only memory (ROM). The memory 404 may store computer-readable, computer-executable code including instructions that, when executed by the processor 402 cause the device 400 to perform various functions described herein. The code may be stored in a non-transitory computer-readable medium such as system memory or another type of memory. In some implementations, the code may not be directly executable by the processor 402 but may cause a computer (e.g., when compiled and executed) to perform functions described herein. In some implementations, the memory 404 may include, among other things, a basic I/O system (BIOS) which may control basic hardware or software operation such as the interaction with peripheral components or devices.

The I/O controller 408 may manage input and output signals for the device 400. The I/O controller 408 may also manage peripherals not integrated into the device M02. In some implementations, the I/O controller 408 may represent a physical connection or port to an external peripheral. In some implementations, the I/O controller 408 may utilize an operating system such as iOS®, ANDROID®, MS-WINDOWS®, OS/2®, UNIX®, LINUX®, or another known operating system. In some implementations, the I/O controller 408 may be implemented as part of a processor, such as the processor 402. In some implementations, a user may interact with the device 400 via the I/O controller 408 or via hardware components controlled by the I/O controller 408.

In some implementations, the device 400 may include a single antenna 410. However, in some other implementations, the device 400 may have more than one antenna 410 (i.e., multiple antennas), including multiple antenna panels or antenna arrays, which may be capable of concurrently transmitting or receiving multiple wireless transmissions. The transceiver 406 may communicate bi-directionally, via the one or more antennas 410, wired, or wireless links as described herein. For example, the transceiver 406 may represent a wireless transceiver and may communicate bi-directionally with another wireless transceiver. The transceiver 406 may also include a modem to modulate the packets, to provide the modulated packets to one or more antennas 410 for transmission, and to demodulate packets received from the one or more antennas 410. The transceiver 406 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 410 for transmitting the amplified signal into the air or wireless medium.

A receive chain may be configured to receive signals (e.g., control information, data, packets) over a wireless medium. For example, the receive chain may include one or more antennas 410 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

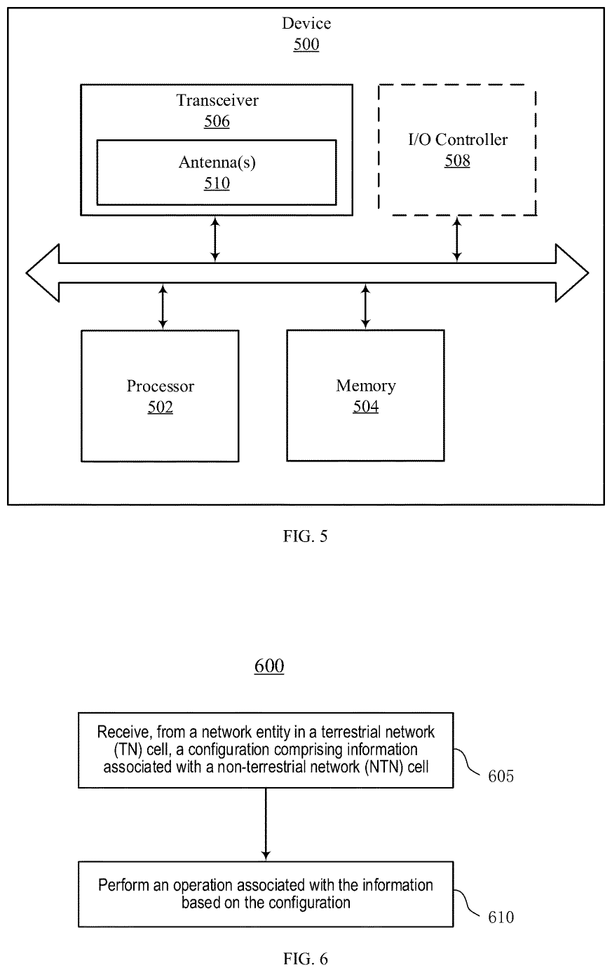

FIG. 5 illustrates an example of a processor 500 that supports performing operations associated with NTN cell information in accordance with aspects of the present disclosure. The processor 500 may be an example of a processor configured to perform various operations in accordance with examples as described herein. The processor 500 may be implemented in a device or its components as described herein. For example, the device may be an example of a UE 104 as described herein. The processor 500 may include a controller 502 configured to perform various operations in accordance with examples as described herein. The processor 500 may optionally include at least one memory 504, such as L1/L2/L3 cache. Additionally, or alternatively, the processor 500 may optionally include one or more arithmetic-logic units (ALUs) 500. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementation, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, and the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 500 may be configured to support various operations in accordance with examples as described herein. In some implementation, the one or more ALUs 500 may reside within or on a processor chipset (e.g., the processor 500). In some other implementations, the one or more ALUs 500 may reside external to the processor chipset (e.g., the processor 500). One or more ALUs 500 may perform one or more computations such as addition, subtraction, multiplication, and division on data. For example, one or more ALUs 500 may receive input operands and an operation code, which determines an operation to be executed. One or more ALUs 500 be configured with a variety of logical and arithmetic circuits, including adders, subtractors, shifters, and logic gates, to process and manipulate the data according to the operation. Additionally, or alternatively, the one or more ALUs 500 may support logical operations such as AND, OR, exclusive-OR (XOR), not-OR (NOR), and not-AND (NAND), enabling the one or more ALUs 500 to handle conditional operations, comparisons, and bitwise operations.

The processor 500 may support wireless communication in accordance with examples as disclosed herein. The processor 500 may be configured to or operable to support a means for receiving, from a network entity in a terrestrial network (TN) cell, a configuration comprising information associated with a non-terrestrial network (NTN) cell; and a means for performing an operation associated with the information based on the configuration.

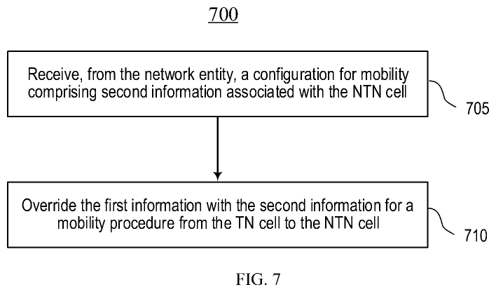

FIG. 6 illustrates a flowchart of a method 600 that supports performing operations associated with NTN cell information in accordance with aspects of the present disclosure. The operations of the method 600 may be implemented by a device or its components as described herein. For example, the operations of the method 600 may be performed by a UE 104 as described herein. In some implementations, the device may execute a set of instructions to control the function elements of the device to perform the described functions. Additionally, or alternatively, the device may perform aspects of the described functions using special-purpose hardware.

At 605, the method may include receiving, from a network entity in a terrestrial network (TN) cell, a configuration comprising information associated with a non-terrestrial network (NTN) cell. The operations of 605 may be performed in accordance with examples as described herein. In some implementations, aspects of the operations of 605 may be performed by a device as described with reference to FIG. 1A.

At 610, the method may include performing an operation associated with the information based on the configuration. The operations of 610 may be performed in accordance with examples as described herein. In some implementations, aspects of the operations of 610 may be performed by a device as described with reference to FIG. 1A.

FIG. 7 illustrates a flowchart of a method 700 that supports performing operations associated with NTN cell information in accordance with aspects of the present disclosure. The operations of the method 700 may be implemented by a device or its components as described herein. For example, the operations of the method 700 may be performed by a UE 104 as described herein. In some implementations, the device may execute a set of instructions to control the function elements of the device to perform the described functions. Additionally, or alternatively, the device may perform aspects of the described functions using special-purpose hardware. The method 700 may be deemed as a specific example of the step 610 of the method 600.

At 705, the method may include receiving, from the network entity, a configuration for mobility comprising second information associated with the NTN cell. The operations of 705 may be performed in accordance with examples as described herein. In some implementations, aspects of the operations of 705 may be performed by a device as described with reference to FIG. 1A.

At 710, the method may include overriding the first information with the second information for a mobility procedure from the TN cell to the NTN cell. The operations of 710 may be performed in accordance with examples as described herein. In some implementations, aspects of the operations of 710 may be performed by a device as described with reference to FIG. 1A.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
at least one memory; and
at least one processor coupled with the at least one memory and configured to cause the UE to:
receive, from a network entity in a terrestrial network (TN) cell, a configuration comprising information associated with a non-terrestrial network (NTN) cell; and
perform an operation associated with the information based on the configuration.

2. The UE of claim 1, wherein the at least one processor is configured to cause the UE to determine that a serving cell for the UE receiving the configuration is the TN cell in response to an NTN cell indication being absent from a system information block (SIB) of the serving cell or the configuration not including a serving cell part.

3. The UE of claim 1, wherein the operation comprises skipping starting a timer indicating a validity of the configuration.

4. The UE of claim 1, wherein the operation comprises starting a timer for the NTN cell indicating a validity of the configuration.

5. The UE of claim 4, wherein the timer is started from a system frame or a subframe indicated by an epoch time for the NTN cell based on a timing of the NTN cell or a timing of the TN cell.

6. The UE of claim 4, wherein the operation further comprises skipping indicating a synchronization that is lost to a lower layer of the UE in of response to expiry of the timer.

7. The UE of claim 4, wherein the timer is a first timer, and the operation further comprises one of the following: skipping starting a second timer in response to expiry of the first timer or starting a second timer in response to expiry of the first timer and skipping indicating a synchronization that is lost to a lower layer of the UE in response to expiry of the second timer.

8. The UE of claim 1, wherein the operation comprises starting a timer for the TN cell indicating a validity of the configuration.

9. The UE of claim 8, wherein the timer is started from a system frame or a subframe indicated by an epoch time for the TN cell based on a timing of the TN cell.

10. The UE of claim 8, wherein the operation further comprises skipping indicating a synchronization that is lost to a lower layer of the UE in response to expiry of the timer.

11. The UE of claim 8, wherein the timer is a third timer, and the operation further comprises skipping starting a fourth timer in response to expiry of the third timer or starting a fourth timer in response to expiry of the third timer and skipping indicating a synchronization that is lost to a lower layer of the UE in response to expiry of the fourth timer.

12. The UE of claim 1, wherein the operation comprises skipping requiring a valid version of the configuration in response to expiry of validation of the information.

13. The UE of claim 1, wherein the operation comprises skipping determining a system information block (SIB) comprising the configuration as an essential SIB for the TN cell.

14. The UE of claim 1, wherein the operation comprises one of the following:
in response to a cell indication being absent in the information, determining to use a same physical cell identifier (PCI) in the NTN cell as in the TN cell;
in response to frequency information being absent in the information, determining to use a same frequency in the NTN cell as the TN cell;
in response to a parameter of an epoch time being present in the information, determining that at least one of a system frame number (SFN) or a subframe number indicated in the parameter is based on the TN cell;
in response to a parameter of an epoch time being present in the information, determining that at least one of a SFN or a subframe number indicated in the parameter is based on the NTN cell;
in response to a parameter of an epoch time being absent in the information, determining the epoch time as at an end of a system information window where a SIB comprising the configuration is scheduled in the TN cell;
in response to an indication of validity duration being absent in the information, determining that a validity duration is not applicable for the configuration;
in response to an indication of validity duration being absent in the information, determining that the validity duration of the configuration as a default value; or
in response to an indication of validity duration being absent in the information, determining that the validity duration of the configuration as an infinite value.

15. The UE of claim 1, wherein the information is first information, the UE is in a connected state, and the operation comprises:
receiving, from the network entity, a configuration for mobility comprising second information associated with the NTN cell; and
overriding the first information with the second information for a mobility procedure from the TN cell to the NTN cell.

16. The UE of claim 1, wherein the information is first information, the UE is in a connected state, and the operation comprises, in response to a configuration for mobility comprising second information associated with the NTN cell not being received from the network entity, utilizing the first information for a mobility procedure from the TN cell to the NTN cell.

17. The UE of claim 1, wherein the information is first information, the network entity is a first network entity, the UE is in an idle state or an inactive state, and the operation comprises:
receiving, from a second network entity, a configuration for mobility comprising third information associated with the NTN cell; and
overriding the first information with the third information for a mobility procedure from the TN cell to the NTN cell.

18. (canceled)

19. A method performed by a user equipment (UE), comprising:
receiving, from a network entity in a terrestrial network (TN) cell, a configuration comprising information associated with a non-terrestrial network (NTN) cell; and
performing an operation associated with the information based on the configuration.

20. A processor for wireless communication, comprising:
a controller coupled with at least one memory and configured to cause the processor to:
receive, from a network entity in a terrestrial network (TN) cell, a configuration comprising information associated with a non-terrestrial network (NTN) cell; and
perform an operation associated with the information based on the configuration.

21. A network equipment (NE) of a terrestrial network (TN), comprising:
at least one memory; and
at least one processor coupled with the at least one memory and configured to cause the NE to:
determine a configuration comprising information associated with a non-terrestrial network (NTN); and
transmit the configuration to a user equipment (UE) for performing an operation associated with the information based on the configuration.
